(19) United States
(12) Patent Application Publication
(10) Pub. No.: US 2013/0177374 A1
(43) Pub. Date: Jul. 11, 2013

(54) LOAD-HANDLING APPARATUS ADAPTED TO BE MOUNTED ON AN ELEVATABLE LIFT CARRIAGE OF A LIFT TRUCK AS WELL AS A LIFT TRUCK COMPRISING SUCH A LOAD-HANDLING APPARATUS

(71) Applicant: Robert Servaas Matti, Valkenburg (NL)

(72) Inventor: Robert Servaas Matti, Valkenburg (NL)

(73) Assignee: ROGAMA B.V., Valkenburg (NL)

(21) Appl. No.: 13/807,846

(22) PCT Filed: Jun. 24, 2011
(86) PCT No.: PCT/NL11/50457

§ 371 Date: Mar. 22, 2013

(30) Foreign Application Priority Data
Jun. 29, 2010 (NL) 2004999

(51) Int. Cl. B66F 9/14

(52) U.S. Cl. CPC B66F 9/142
USPC 414/667

(57) ABSTRACT

The invention relates to a load-handling apparatus (1) adapted to be mounted on an elevatable lift carriage of a lift truck, wherein the load-handling apparatus comprises a frame having at least four parallel guides (5, 7, 9, 11) making up a first pair of parallel abutting guides (13) and a second pair of parallel abutting guides (15), at least two oppositely directed and hydraulic actuated piston cylinders, wherein at least two outer load-handling arms are connectable to said hydraulic actuated piston cylinders (25, 27) for moving said outer load-handling arms (3) with regard to said guides to and from each other for engaging a load and at least two inner load-handling arms (4) of which each is connected to at least one spring (101, 103) for keeping a fixed position of said inner load-handling arms to the frame during movement of the outer load-handling arms over a predetermined distance.

The invention relates to a load-handling apparatus adapted to be mounted on an elevatable lift carriage of a lift truck, wherein the load-handling apparatus comprises a frame having at least four parallel guides making up a first pair of parallel abutting guides and a second pair of parallel abutting guides, at least two oppositely directed and hydraulic actuated piston cylinders, wherein at least two outer load-handling arms are connectable to said hydraulic actuated piston cylinders for moving said outer load-handling arms with regard to said guides to and from each other and at least two inner load-handling arms of which each is connected to at least one spring for keeping a fixed position of said inner load-handling arms to the frame during movement of the outer load-handling arms over a predetermined distance, wherein the inner load-handling arms are slidably supported by means of at least one additional guide.

The invention further relates to lift truck comprising such a load-handling apparatus.

Such a load-handling apparatus and lift truck are known from DE-20.2006.005.178U1. This patent document describes outer load-handling arms that can be operated by two oppositely directed and hydraulic actuated piston cylinders and two inner load-handling arms of which the first inner load-handling arm is connected to the frame of the apparatus by a first spring construction at a first location on the frame and guided by a first additional guide located next to the first spring and the second inner load-handling arm is connected to the frame of the apparatus by a second spring construction at a second location on the frame and the second inner load-handling arm is guided by a second additional guide located at a different location on the frame. After the movement of the outer load-handling arms in an outward direction has traveled a certain distance, the inner load-handling arms are moved against spring force outwardly to a maximum distance between the inner and the outer load-handling arm.

A drawback of the load-handling apparatus known is that it is not compact. In addition the spring construction is openly positioned in the frame which makes the springs vulnerable for damage and it causes a reduction of the visibility for the lift-truck driver through the frame. Further, said load handling apparatus has a relatively large weight.

It is therefore an object of the present invention to provide a compact dimensioned load-handling apparatus in a manner compatible with maximum strength.

This object is accomplished with the load-handling apparatus according to the present invention in that the springs for the inner load-handling arms are integrated in said at least one additional guide such that at least one spring guide is provided, wherein the outer dimensions of the spring guide are defined by means of the springs wounded around said at least one additional guide or the outer dimensions of the spring guide are defined by means of the additional guide housing the springs.

In the load-handling apparatus according to the present invention there is at least one compact spring guide that combines the guiding function with the spring function. In this way the space needed for the springs on the frame is reduced and a more compact load-handling apparatus is provided with improved visibility. Further, by integrating the springs with the guide a weight reduction is achieved. A light weight apparatus is advantageous as with the same lift truck more kilograms of weight can be lifted.

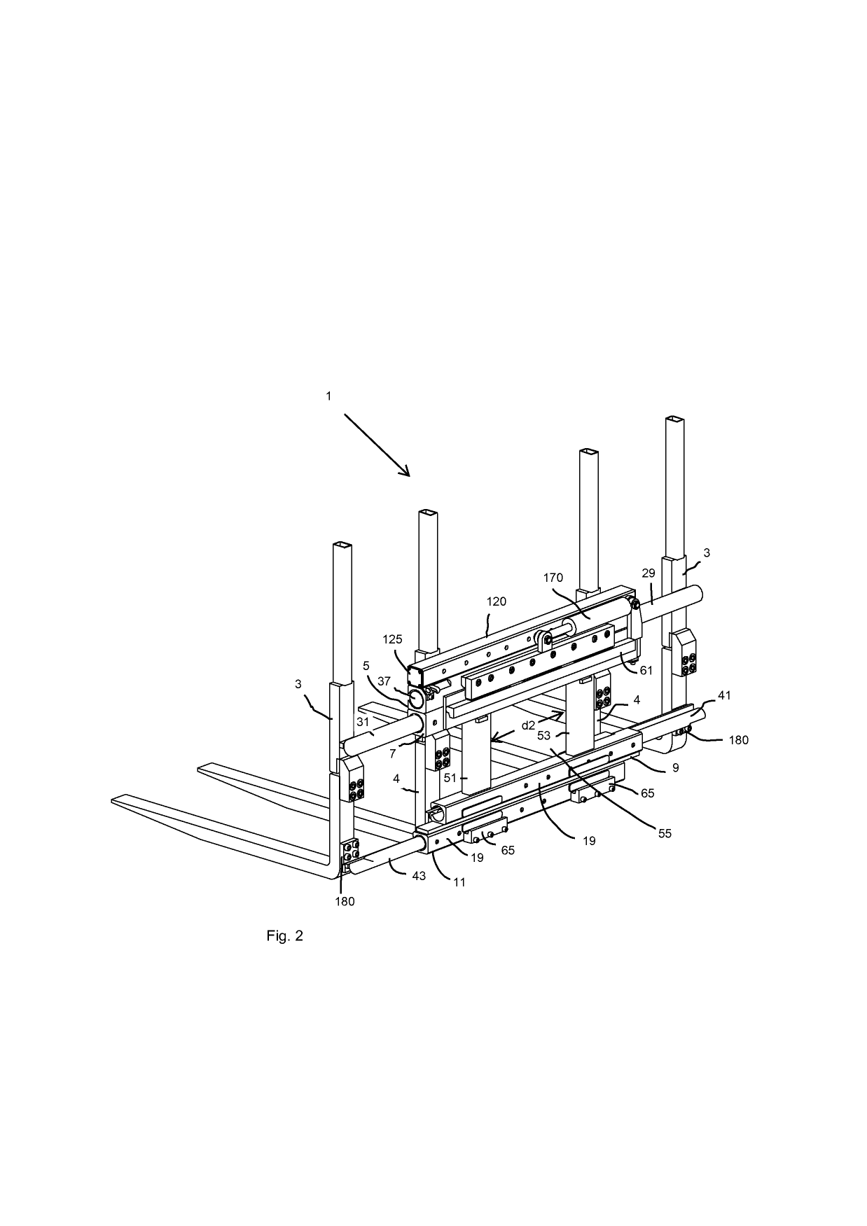

EP-0.515.996 discloses a load handling apparatus adapted to be mounted on an elevatable lift carriage of a lift truck. Said load handling apparatus comprises a stationary frame (1) consisting of lateral cheeks (2) and a top and bottom supporting and guide tube (3, 4) connecting the cheeks. On guide tubes (3, 4) of the frame supporting beams (7, 8) are held in such a way as to be displaceable in a sliding manner on the frame (2, 3, 4). Supporting beams (7, 8) comprise bores (11, 12, 13, 14), i.e. first bores (13, 14) supporting slidably guide tubes (15, 16, 15′, 16′), and second bores (11, 12) of the supporting beams (7, 8) are slidably supporting itself on the guide tubes (3, 4) of the frame. With regard to the present invention the frame of EP-0.515.996 does not comprise four parallel guides making up a first pair of parallel abutting guides and a second pair of parallel abutting guides. Further, no additional guide having integrated springs can be found in the construction of EP-0.515.996 for supporting the inner load-handling arms (9, 10). In fact, as already indicated the first bores (13, 14) of the supporting beams support said slidably guide tubes (15′, 16′) comprising a spring (31) and not vice versa. In addition, the outer dimensions of guide tubes (15′, 16′) are defined by means of the stop (23) mounted on the housing of guide tubes (15′, 16′). A disadvantage of the known load-handling apparatus is that the springs are positioned openly in the frame and therefore these springs are not properly protected. Further, it is a disadvantage of the construction known from EP-0.515.996 that in its rest position as shown in FIG. 2, in which position the load handling apparatus has minimum dimensions beneficial for storage of the load handling apparatus and which position is also used for handling single loads, the hydraulic piston/cylinder arrangement (19; 20) needs to keep the springs maximally pressed. In this way a small leakage in the hydraulic piston/cylinder arrangement will result in a movement of the outer load-handling arms to the outside position from the inner load-handling arms which movement is a result of the spring force of the springs. In addition the constant maximum spring pressure for holding the outer load handling arms in the position shown in FIG. 2 of EP-0.515.996 increases the risks of leakages in the hydraulic system.

One embodiment of the load handling apparatus according to the present invention is characterized in that said two springs for said two inner load-handling arms are located in one spring guide such that a first spring is connected to the first inner load-handling arm at substantially the same vertical height measured from ground level as a second spring is connected to the second inner load-handling arm.

By providing only one spring guide with two springs for positioning, guiding and supporting two inner load-handling arms an even more compact design of the load handling apparatus is provided.

In some cases the inner load-handling arms may alternatively also be supported by two separate spring guides. For example a load-handling apparatus according to the present invention with four or six inner load-handling arms has to include more than one spring guide to support and position the inner load-handling arms.

Another embodiment of the load handling apparatus according to the present invention is characterised in that the first ends of the springs are connected to diametrically opposed inner sides of the spring guide, wherein the second ends of the springs are connected to the inner load-handling arms in such a way that the spring is pushing the inner load handling arms to each other.

Preferably, instead of a spring pulling the inner load-handling arms to each other, the springs used in the apparatus according to the present invention push the load handling arms to each other. By using “push” springs instead of “pull” springs a more compact design of the spring guide housing two oppositely directed springs can be provided. In the present invention the spring force pushes the inner load-handling arms from the frame, i.e. the spring guide to each other. The spring force has no influence on the distance between the inner and outer load-handling arms on each side. The movement of the outer load-handling arms is only caused by means of the at least two oppositely directed and hydraulic actuated piston cylinders.

A further embodiment of the load handling apparatus according to the present invention is characterised in that the at least two oppositely directed and hydraulic actuated piston cylinders are located inside the guides.

In this way the guides in which these oppositely directed and hydraulic actuated piston cylinders are located, have two functions, i.e. guiding and moving the load handling arms such that the load-handling apparatus according to the present invention is constructed in an even more compact manner with an improved visibility as the viewing window is not reduced by piston cylinders.

Another embodiment of the load handling apparatus according to the present invention is characterised in that each piston cylinder being slidably and non-rotatably disposed in one of the guides, wherein each piston cylinder comprises a stationary piston element and a stationary rod secured with one end to said piston element, and pivotally secured at its opposite end to said guide.

By pivotally securing the stationary rod to said guide a flexible connection is provided for absorbing forces in use of the load handling apparatus such that maintenance for this connection is reduced drastically compared to a load-handling apparatus having a rigid connection.

A further embodiment of the load handling apparatus according to the present invention is characterised in that each piston cylinder is provided with a cylinder housing having a projecting element which is moveable over the predetermined distance from a first position to a second position in which position the projecting element engages the inner load-handling arm for moving said inner load-handling arm against spring force of the spring in an outward direction to a third position.

In this way the inner load-handling arms are driven without special driving means as the piston cylinder moving the outer load-handling arm also drives one of the inner load-handling arms. Only one piston cylinder for movement of one of the inner load-handling arms and one of the outer load-handling arms provides a compact design of the apparatus according to the present invention.

Another embodiment of the load handling apparatus according to the present invention is characterised in that each load-handling arm comprises an upper part which is detachably connected to a lower part.

During use the load handling arms wear and more in particular the lower part of the L-shaped load handling arms wears significant during use of the load handling apparatus by regularly sliding over the ground, whereas the upper part does hardly wear during normal use. Therefore, it is essential that the lower part is made interchangeable and by detachably connecting the upper part to the lower part, it is possible to change the lower part in efficient way. In all known load handling apparatus of this kind the complete load handling arms have to be replaced.

A further embodiment of the load handling apparatus according to the present invention is characterised in that the load-handling arm comprises a coupling unit for coupling said upper part with the lower part of the load-handling arm, wherein in an assembled state said coupling unit is located at a height corresponding with the viewing window provided in the frame such that the construction depth of the load handling apparatus is not influenced by means of said coupling means.

Preferably, all load handling arms, i.e. both inner and outer load handling arms, more in particular the lower interchangeable parts thereof, are made substantially identical. In this way changing parts of the load handling apparatus is quite simple and accidents can be prevented as only one type of lower part fits all upper parts of the load handling apparatus and it is no longer possible to couple a wrong lower part to a inner or outer upper part. In addition, maintenance costs are reduced.

A further embodiment of the load handling apparatus according to the present invention is characterised in that the guides of the second pair of the parallel abutting guides have at least a smaller depth-dimension than the guides of the first pair of the parallel abutting guides.

By providing the lower or second pair of the parallel abutting guides with a smaller depth dimension, the design of the load-handling apparatus is more compact and lightweight. Further, by staggering the guides in the lower pair relative to each other in the longitudinal direction for a predetermined distance of the length of the guides, the guides can be made shorter and therefore lighter.

Another embodiment of the load handling apparatus according to the present invention is characterised in that the space created by the smaller depth-dimension of the guides of the lower pair is used to couple the load-handling arms in a detachably manner with the slidable supports in the guides.

As the lower part of the load handling arm is preferably made interchangeable and the dimensions of the apparatus have to be compact, it is possible to provide a detachable coupling between the lower guides and the load handling arm to be connected therewith. Preferably, the inner load handling arms are coupled in a hooked manner with the slidable supports. This is possible as the inner load-handling arms always remain positioned within the total width of the load-handling apparatus.

By detaching the coupling between the slidable supports and the load handling arm connected therewith and by detaching the upper and lower part of the same load handling arm, this part can be changed in an efficient manner.

A further embodiment of the load handling apparatus according to the present invention is characterised in that the guides of the second pair of the parallel abutting guides have at least a smaller height-dimension than the guides of the first pair of the parallel abutting guides.

In this way a larger viewing space for an operator is provided in a load handling apparatus having substantially the same dimensions.

Another embodiment of the load handling apparatus according to the present invention is characterised in that an outer shape of the hydraulic actuated piston cylinder is cylindrical such that an inner sliding surface of the guide is shaped cylindrical, whereas the outer sides of at least one guide of a pair comprise at least one flat contact surface to be connected with the elevatable lift carriage of a lift truck.

Preferably no back plate is available for mounting said load-handling apparatus to be connected to the elevatable lift carriage of a lift truck. Therefore at least one flat contact surface needs to be provided such that the load handling apparatus can be connected directly to the elevatable lift carriage of a lift truck with maximum strength.

A further embodiment of the load handling apparatus according to the present invention is characterised in that said apparatus is provided with a device for moving the load handling apparatus in a sideward direction, which device is connected to one of the guides of the upper pair of guides. The piston cylinder for actuating the side-shift function is preferably positioned behind the spring guide with the advantage that it does not reduce the visibility in any way.

Such a device is known per se and provides a side shift function to the load handling apparatus according to the present invention.

The invention will now be explained in more detail with reference to an exemplary embodiment shown in the appended figures, in which:

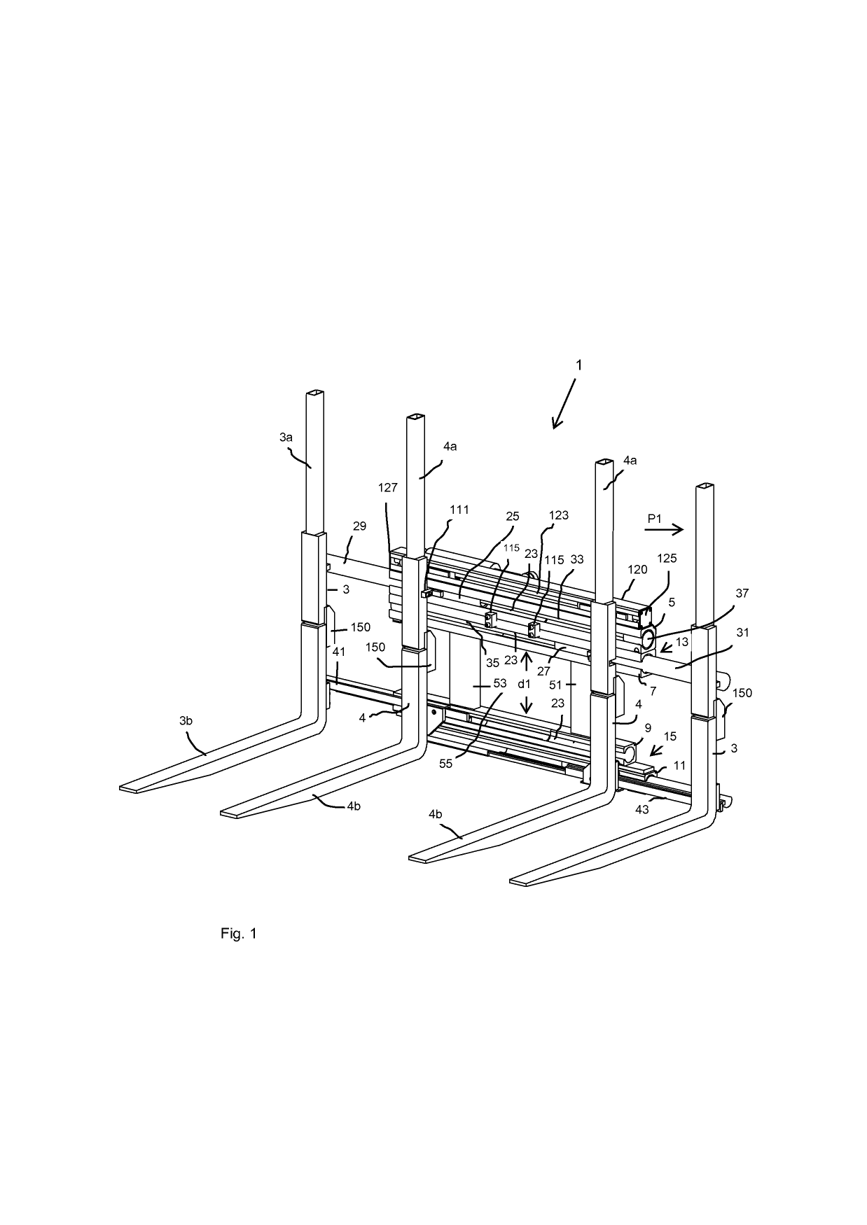

FIG. 1 shows a perspective front view of a load handling apparatus according to the invention, wherein load handling arms are shown in a spaced apart position,

FIG. 2 shows a perspective back view of a load handling apparatus according to the invention shown in FIG. 1,

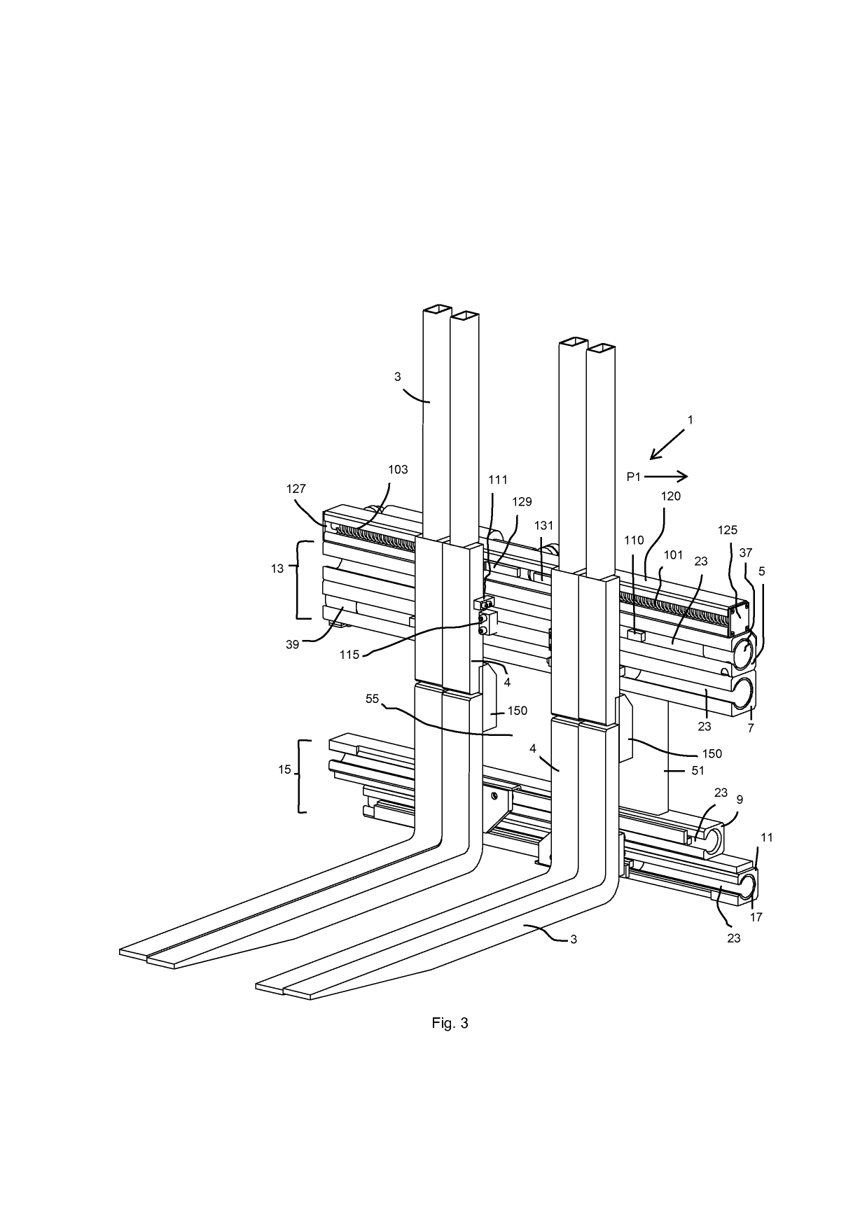

FIG. 3 shows a perspective front view of a load handling apparatus according to the invention, wherein load handling arms are closely spaced;

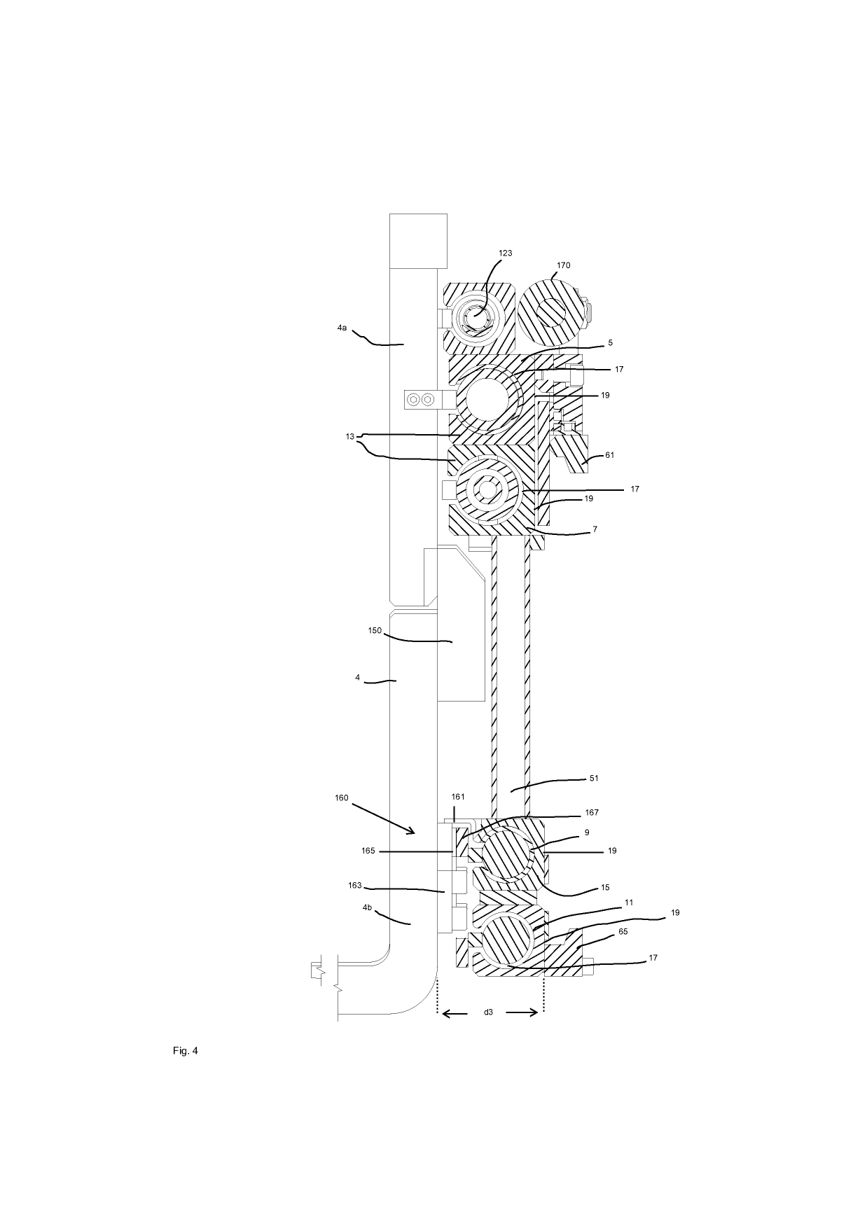

FIG. 4 is a sectional view of a load handling apparatus according to the invention.

Like parts are indicated by the same numerals in the various figures.

The load-handling apparatus 1 shown in FIGS. 1-4 uses four fork-type load-handling arms 3, 4 capable not only of insertion underneath the bottom of a load (not shown), but also capable of engaging the opposite exterior or interior side surfaces of a load by providing lateral clamping force thereon to lift the load. It will be understood that any type load-handling arms may be used instead of the fork-type load-handling arms 3, 4 shown in the appended figures. In the apparatus 1 according to the present invention there are two types of load-handling arms 3, 4: Outer load-handling arms 3 and inner load-handling arms 4.

The load-handling apparatus 1 shown comprises four parallel guides 5, 7, 9, 11 making up a first pair 13 of parallel abutting guides 5, 7 and a second pair 15 of parallel abutting guides 9, 11. Said first pair 13 is vertically spaced relative to said second pair 15. The guides 5, 7, 9, 11 are substantially identical. Each pair 13, 15 comprises two rectangle-shaped guides 5, 7, 9, 11, of which a top surface of a first guide 7, 11 has been welded to a bottom surface of a second guide 5, 9. The back side 19 of each guide 5, 7, 9, 11 is a flat contact surface for providing a strong connection with an elevatable lift carriage (not shown) of a lift truck (not shown). The front side 21 of each guide 5, 7, 9, 11 comprises a slot 23 facing the load-handling arms 3, which slot 23 extends from one end of the guide to another longitudinally opposing end of the guide. Further, each guide 5, 7, 9, 11 comprises a hollow interior, in which an inner surface is shaped cylindrical for defining a smooth sliding surface. This sliding surface 17 is formed by a sliding bushing 17.

Within the first upper pair 13 of guides 5, 7 two oppositely directed and hydraulic actuated piston cylinders 25, 27 are situated. Each piston cylinder 25, 27 comprises a slidable and non-rotatable cylinder housing 29, 31, a stationary piston element (not shown) located in said cylinder housing 29, 31 and a stationary piston rod 33, 35 secured with one end to said piston element and secured at its opposite end to a supporting element 37, 39, which supporting element 37, 39 is pivotally secured to said guide 5, 7. A pivotal connection between the piston rod 33, 35 and the guide 5, 7 is advantageous for absorbing forces during use of the load handling apparatus 1.

Within the second pair 15 of guides two slidable supports 41, 43 are provided.

The outer load-handling arms 3 are directly connected to the slidable and non-rotatable cylinder housings 29, 31 of said piston cylinders 25, 27 for moving said load-handling arms 3 with regard to said guides 5, 7, 9, 11 to and from each other, wherein each load-handling arm 3 is moveably supported by one guide 5, 9; 7, 11 of each pair 13, 15.

In the load-handling apparatus 1 according to the present invention the second pair 15 is spaced of said first pair 13 with a distance d1 defined by connection elements 51, 53 lying between the first 13 and the second pair 15 in such a way that said connection elements 51, 53 only influence one dimension of the load-handling apparatus 1, i.e. only the vertical dimension of the load-handling apparatus 1 according to the present invention. Said influence of said connection elements 51, 53 to the vertical dimension of the load-handling apparatus 1 according to the present invention defines a viewing window 55 between the lower guide 7 of said first 13 pair and the upper guide 9 of said second pair 15 and said connection elements 51, 53 through which a first side of the load-handling apparatus 1 on which first side the load-handling arms are located, can be viewed from a second side of the load-handling apparatus 1 on which second side in use the lift is connected to said load-handling apparatus 1.

The dimensions of the viewing window 55 are defined by the distances d1 between the first 13 and second pair 15, and the distance d2 between the connection elements 51, 53. Please note that it is possible to position the spring guide 120 instead of on top of the first pair 13 as shown in the drawings, below the first pair in a manner that the guides of pair 13 are moved upwards such that such configuration (not shown) has no influence on the viewing window.

By means of the connection elements 51, 53 a maximally compact dimensioned relatively light-weight load handling apparatus 1 can be provided. The depth dimension d3 (FIG. 4) of the load-handling apparatus 1 with standard capacity in a range of 2500-3500 kg without the arms 3, 4 is approximately 115 mm, whereas depth dimensions of the load-handling apparatus of the prior art are 160 mm or more. Please note, that the depth dimension of the load-handling apparatus 1 is normally calculated without the optional hook-type couplings 61, 65 for mounting said load-handling apparatus 1 to the elevatable lift carriage of a lift truck. By means of said couplings 61, 65 an interchangeable load handling apparatus 1 is provided.

In the load-handling apparatus 1 according to the invention each inner load-handling arm 4 is connected to at least one spring 101, 103 for keeping a fixed position of said inner load-handling arm 4 to the frame formed by the pair 13, 15 of guides and the connection elements 51, 53, during movement of the outer load-handling arms by means of the piston cylinder 25, 27 over a predetermined distance.

The cylinder housing 29, 31 of each piston cylinder 25, 27 is provided with a projecting element 110 which is moveable over the predetermined distance from a first position (shown in FIG. 3) to a second position (not shown) in which position the projecting element 11 engages a stop element 111 of the inner load-handling arm 3 for moving said inner load-handling arm 3 against spring force of the spring 101, 103 in an outward direction as indicated by arrow P1 to a third position which is shown in FIGS. 1 and 2.

In the apparatus 1 according to the present invention said springs 101, 103 for said inner load-handling arms 4 are located in one spring guide 120 such that a first spring 101 is connected to the first inner load-handling arm 4 at substantially the same vertical height measured from ground level as a second spring 103 is connected to the second inner load-handling arm 4.

The spring guide 120 comprises two springs 101, 103 which are supported by a bar 123 over which the springs are positioned in a moveable manner. The first ends of the springs 101, 103 are connected to diametrically opposed sides 125, 127 of the spring guide 120, wherein the second ends of the springs 101, 103 are connected by means of supports 129, 131 to the inner load-handling arms in such a way that the spring is pushing the inner load handling arms 4 to each other in an opposed direction as indicated with arrow P1. The supports 129, 131 are moveable over the bar 123 which extends between said diametrically opposed sides 125, 127 of the spring guide 120. These sides 125, 127 are formed by detachable plates such that easy access is provided, e.g. for maintenance.

The guides of the first pair 13 are provided with a positioning element 115 which define a minimum distance between the inner load-handling arms 4.

The spring guide 120 is located on a top side of the upper guide 5 of the upper pair 13 of guides.

Each load-handling arm 3, 4 comprises an upper part 3a, 4a which is detachably connected by means of a coupling unit 150 to a lower part 3b, 4b of each load-handling arm 3, 4. The coupling unit 150 can be bolted to both the upper and the lower part 3b, 4b of each load-handling arm 3, 4 or it is possible that this coupling unit 150 is welded to one of the two parts 3a, 4a, 3b, 4b and only bolted to the other part. Of course, it is possible to use any other type of rapid coupling than bolts.

The guides 9, 11 of the second pair 15 of the parallel abutting guides have smaller dimensions than the guides 5, 7 of the first pair 13 of the parallel abutting guides for providing a more compact and lightweight design of the load-handling apparatus. In addition a larger viewing space for an operator is provided.

Further, by staggering the guides in the lower pair relative to each other in the longitudinal direction for a predetermined distance of the length of the guides, the guides can be made shorter and therefore lighter.

By positioning the guides 9, 11 of the second pair 15 in a more backward manner compared to the guides 5, 7 of the first pair 13 in addition to the smaller dimensions, a volume can be created on a side of the guides 9, 11 of the second pair 15 facing the load handling arms that can be used for coupling means 160, 180 to couple the load-handling arms 3, 4, more in particular the lower parts 3b, 4b of each load-handling arm 3, 4, in a detachably manner with the slidable supports 41, 43 of the guides 9, 11. As during normal use only the lower parts 3b, 4b of each load-handling arm 3, 4 wear, only these parts 3b, 4b have to be made interchangeable.

The lower parts 3b of each outer load-handling arm 3 are detachably connected, e.g. with bolts, to the slidable supports 41, 43 of the guides 9, 11 through the connection plate 180. The connection plate 180 is welded or by other means connected to the slidable supports 41, 43 of the guides 9, 11.

The slidable supports 41, 43 have a part which fits and slides into the lower pair of guides 15 and a T- or L-shaped part 167 protruding through the slot of guides 9 and 11. The T-shaped part improves the strength of the lower slidable supports 41 and 43 while extending out of the frame and provides at the same time a support for the inner load-handling arms 4b as they always remain within the frame width and remain supported by the T-shaped part 167.

Each coupling means 160 comprises at least a hook 161, a connection plate 163 bolted to the lower parts 4b of each inner load-handling arm 4 and wearing plate 165 such that the connection piece 167 connected to slidable cylindrical supports 41, 43 can be moved relative to the connection plate 163 bolted to the lower parts 4b of each inner load-handling arm 4. The hook 161 prevents the inner load-handling arms from coming loose from the slidable supports 41, 43 in use.

As the inner and outer load-handling arms move as pair with the fixed distance there between determined by the spring construction from a second to a third position (third position is shown in FIGS. 1 and 2) the inner load-handling arms 4b rest without relative movement on the T-shaped part 167 of the slidable supports 41, 43.

In this way the detachable connection of the inner and outer load-handling arms to the slidable supports 41, 43 lies within the height dimension of the second pair of guides 15. Further, they have no influence on the dimensions of the viewing window.

At the same time the connection plates 163 of the inner load-handling arms and the connection plate 180 of the outer load-handling arms and their couplings (preferably bolts) use the space created by the smaller depth dimension of the second pair of guides 15. In this way the detachable connection of the load-handling arms 3,4 with the slidable supports 41, 43 does not increase the construction depth of the load handling apparatus 1.

The apparatus 1 shown is further provided with a device 170 for moving the load handling apparatus as a whole in a sideward direction, which device 170 detachably connected to the back side 19 of the upper guide 5 of the upper pair 13 of guides. The device 170 comprises one of the hook-type couplings 61 for mounting said load-handling apparatus 1 to the elevatable lift carriage of a lift truck.

The first pair 13 of guides 5, 7 comprise a centrally arranged hydraulic fluid discharge and supply unit (not shown) for the hydraulic actuated piston cylinders 25, 27 which is positioned on a front-side facing the load-handling arms 3.

Further, it is important that the width of said connection elements 51, 53 does preferably not exceed the depth dimension of the guides 5, 9, 7, 11 such that the construction depth of the apparatus 1 is not influenced by the connection elements and an optimal viewing window and also viewing spaces 71, 73 are provided on a side of the connection elements 51, 53 opposite of the viewing window 55.

In addition, the two connection elements 51, 53 of the load handling apparatus are spaced relatively to each other with a distance d2 corresponding to a horizontal distance between vertically extending lift masts (not shown) of the lift truck for optimizing visibility through said viewing window 55.

It is possible and known as such to provide for specific purposes more than four moveable load handling arms e.g. six or more moveable load handling arms to the load-handling apparatus 1. These multiple inner forks, always remain positioned inside the frame width of the apparatus 1. However it can be necessary to have an extra guide for these supplementary inner forks. The spring construction to position these supplementary inner forks is preferably integrated inside the guide of these inner forks.

Despite the above description and the appended claims it is also possible that the embodiment covering the guides of the second pair of the parallel abutting guides having at least a smaller depth-dimension than the guides of the first pair of the parallel abutting guides, is claimed independently from the springs (see appended claims) located in at least one spring guide. Therefore, this description also provides basis for a load-handling apparatus adapted to be mounted on an elevatable lift carriage of a lift truck, wherein the load-handling apparatus comprises a frame having at least four parallel guides making up a first pair of parallel abutting guides and a second pair of parallel abutting guides, wherein the first pair is vertically spaced relative to the second pair, at least two oppositely directed and hydraulic actuated piston cylinders, wherein at least two load-handling arms are connectable to said hydraulic actuated piston cylinders for moving said outer load-handling arms with regard to said guides to and from each other for engaging a load, wherein the guides of the second pair of the parallel abutting guides having at least a smaller depth-dimension than the guides of the first pair of the parallel abutting guides.

Despite the above description and the appended claims it is also possible that the embodiment covering interchangeability of the lower part of each load handling arm by means of the coupling unit 150 without requiring additional space, is claimed independently from the springs (see appended claims) located in at least one spring guide. In all known load handling apparatus of the type described herein the complete load handling arms have to be replaced.

It is possible that the lower part of the inner load handling arms is guided by means of an extra additional spring guide.

The connection elements 51, 53 are located between the first 13 and the second pair 15 in a way that the spring guide 120 may be coupled to the upper or lower pair of guides in a way that the viewing window is defined by one of these pair of guides 13, 15 and said spring guide in combination with the connection elements 51, 53. Further, the connection elements 51, 53 are positioned and dimensioned in such a way that said connection elements only influence one dimension of the load-handling apparatus 1, i.e. the height dimension. This means that the connection elements do no protrude in a backward manner relative to the backside of the frame, having no back plate and thus formed by the pair of guides positioned in a the most backward manner.

1. A load-handling apparatus adapted to be mounted on an elevatable lift carriage of a lift truck, wherein the load-handling apparatus comprises:
a frame having at least four parallel guides making up a first pair of parallel abutting guides and a second pair of parallel abutting guides,
at least two oppositely directed and hydraulic actuated piston cylinders, wherein at least two outer load-handling arms are connectable to said hydraulic actuated piston cylinders for moving said outer load-handling arms with regard to said guides to and from each other and at least two inner load-handling arms of which each is connected to at least one spring for keeping a fixed position of said inner load-handling arms to the frame during movement of the outer load-handling arms over a predetermined distance, wherein the inner load-handling arms are slidably supported by means of at least one additional guide, characterised in that the springs for the inner load-handling arms are integrated in said at least one additional guide such that at least one spring guide is provided, wherein the outer dimensions of the spring guide are defined by means of the springs wounded around said at least one additional guide or the outer dimensions of the spring guide are defined by means of the additional guide housing the springs.

2. A load-handling apparatus according to claim 1, wherein said two springs for said two inner load-handling arms are located in one spring guide such that a first spring is connected to the first inner load-handling arm at substantially the same vertical height measured from ground level as a second spring is connected to the second inner load-handling arm.

3. A load-handling apparatus according to claim 1, wherein the first ends of the springs are connected to diametrically opposed inner sides of the spring guide, wherein the second ends of the springs are connected to the inner load-handling arms in such a way that the spring is pushing the inner load handling arms to each other.

4. A load-handling apparatus according to claim 1, wherein the at least two oppositely directed and hydraulic actuated piston cylinders are located inside the guides.

5. A load-handling apparatus according to claim 4, wherein each piston cylinder being slidably and non-rotatably disposed in one of the guides, wherein each piston cylinder comprises a stationary piston element and a stationary rod secured with one end to said piston element, and pivotally secured at its opposite end to said guide.

6. A load-handling apparatus according to claim 5, wherein each piston cylinder is provided with a cylinder housing having a projecting element which is moveable over the predetermined distance from a first position to a second position in which position the projecting element engages the inner load-handling arm for moving said inner load-handling arm against spring force of the spring in an outward direction to a third position.

7. A load-handling apparatus according to claim 1, wherein each load-handling arm comprises an upper part which is detachably connected to a lower part.

8. A load-handling apparatus according to claim 7, wherein the load-handling arm comprises a coupling unit for coupling said upper part with the lower part of the load-handling arm, wherein in an assembled state said coupling unit is located at a height corresponding with the viewing window provided in the frame such that the construction depth of the load handling apparatus is not influenced by means of said coupling means.

9. A load-handling apparatus according to claim 1, wherein the lower part of each load-handling arm is detachably connectable to one of the slidable supports in the guides of the lower pair of guides.

10. A load-handling apparatus according to claim 1, wherein the guides of the second pair of the parallel abutting guides have at least a smaller depth-dimension than the guides of the first pair of the parallel abutting guides.

11. A load-handling apparatus according to claim 10, wherein the space created by the smaller depth-dimension of the guides of the lower pair is used to couple the load-handling arms in a detachably manner with the slidable supports in the guides.

12. A load-handling apparatus according to claim 1, wherein the guides of the second pair of the parallel abutting guides have at least a smaller height-dimension than the guides of the first pair of the parallel abutting guides.

13. A load-handling apparatus according to claim 1, wherein an outer shape of the hydraulic actuated piston cylinder is cylindrical such that an inner sliding surface of the guide is shaped cylindrical, whereas the outer sides of at least one guide of a pair comprise at least one flat contact surface to be connected with the elevatable lift carriage of a lift truck.

14. A load-handling apparatus according to claim 1, wherein, the apparatus is provided with a device for moving the load handling apparatus in a sideward direction, which device is connected to one of the guides of the upper pair of guides.

15. A load-handling apparatus according to claim 1, wherein, connection elements lying between the first and the second pair are positioned and dimensioned in such a way that said connection elements only influence one dimension of the load-handling apparatus, wherein said influence of said connection elements defines a viewing window through which a first side of the load-handling apparatus can be viewed from a second side of the load-handling apparatus.

16. Lift truck comprising a load-handling apparatus according to claim 1.
